(19) United States
(12) Patent Application Publication
(10) Pub. No.: US 2018/0328101 A1
(43) Pub. Date: Nov. 15, 2018

(54) MULLION-TRANSOM STRUCTURE

(71) Applicant: SCHÜCO INTERNATIONAL KG, Bielefeld (DE)

(72) Inventors: Emal Ander, Bad Salzuflen (DE); Peter Molitor, Steinhagen (DE); Juergen Meyer, Bad Oeynhausen (DE); Falk Meyer, Lemfoerde (DE)

(21) Appl. No.: 15/543,334

(22) PCT Filed: Dec. 29, 2015
(86) PCT No.: PCT/EP2015/081363

§ 371 Date: Jul. 13, 2017

(30) Foreign Application Priority Data
Jan. 14, 2015 (DE) 10 2015 100 523.9
Jan. 14, 2015 (DE) 10 2015 100 525.5

(51) Int. Cl. E06B 3/263; E06B 3/26; E06B 3/54; E06B 3/64; E04B 2/96

(52) U.S. Cl. CPC E06B 3/26305; E06B 3/26; E06B 3/5409; E04B 2/967; E06B 3/64; E04B 2/965; E06B 3/549

(57) ABSTRACT

A mullion-transom structure has a supporting profiled element on which at least one filling element is retained at an edge, and a pressing strip by which at least one filling element is pressed toward the supporting profiled element. The pressing strip is retained on the supporting profiled element by at least one fastener, which fastener engages in a groove on the supporting profiled element. The groove is formed with an undercut and the at least one fastener is displaceably retained with a head segment in the groove. Preferably, the fastener embodies a bolt connected to a head segment, which head segment is pivotably held in a pre-mounted position on the groove of the supporting profiled element.

The present invention relates a mullion-transom structure, comprising a supporting profiled element, on which at least one filling element is retained at the edge, and comprising a pressing strip, by means of which the at least one filling element is pressed toward the supporting profiled element, wherein the pressing strip is retained on the supporting profiled element by means of at least one fastening means and the at least one fastening means engages in a groove on the supporting profiled element.

EP 1 346 114 discloses a mullion-transom structure, in which supporting profiled elements are provided which have a screw groove in the centre in order to fix a pressing strip by means of screws. The screw groove projects into an intermediate space between end faces of adjacent filling elements. Drain channels are formed adjacent to the screw groove, which are delimited on the side facing away from the screw groove by a groove for fixing a sealing strip. This construction has proven itself per se, but the formation of a screw groove with adjacent drain channels leads to a greater width of the supporting profiled elements. In addition, the screw groove protrudes from the supporting profiled element and therefore a security distance must be provided between the end faces of the filling elements and the screw groove.

WO 2005/035901 A1 discloses a framework for a façade in which a groove is provided on a profile carrier, into each of which a head of a threaded pin is inserted. A tensioning washer is clamped on the threaded pin via a nut to the outer side of glass panes in order to fix them in a clamping manner between the sealing strips. The head of the threaded pin is received in the groove in a substantially interlocked manner, so that a displacement of the threaded pins is possible, but no pivoting about an axis parallel to the longitudinal direction of the groove. When the glass panes are mounted, contact between the metal threaded pins and the edges of the glass panes can occur, which can lead to damage due to the rigid positioning of the threaded pins.

DE 41 05 208 A1 discloses a building façade structure in which a plurality of connector elements, which serve to mount a pressing strip, are fixed to a groove on a supporting profiled element. Via the pressing strip, the glazing elements on the supporting profiled element are clamped via sealing profiles. The central groove on the supporting profiled element is formed in the manner of undercuts and has a receptacle for a braking profile made from an elastic material. As a result, the connector elements can also be secured in a force-locked manner in addition to the interlocked connection with the groove. Because of the interlocked connection between the groove and the connector elements, a pivoting movement of the connector elements about an axis parallel to the longitudinal direction of the groove is also prevented in this case, so that damage can occur when the edges of the glass panes come into contact with the connector elements.

A further façade structure is shown in U.S. Pat. No. 3,367,077. Bolts are displaceable on a groove of a mullion, but are otherwise rigidly mounted, which serve to clamp a pressing strip. For this purpose nuts are screwed onto the bolts on the outer side.

It is therefore an object of the present invention to provide a mullion-transom structure which has good thermal insulation and is easy to mount, and to further provide a simple mounting method.

This object is achieved by a mullion-transom structure having the features of claim 1 or 14 and by a method with the features of claim 19.

In the mullion-transom structure according to the invention, the pressing strip is held by at least one fastening means on the supporting profiled element, which engages in a groove on the supporting profiled element, wherein the groove has an undercut design and the at least one fastening means is displaceably retained in the groove by means of a head segment. As a result of the undercut design of the groove, it is ensured that the pressing strip can be fixed by the fastening means to the outer side of the filling elements, wherein the groove can be formed compactly since the groove walls do not form a screw channel but only engage behind the head segment. Furthermore, the mounting of the at least one fastening means is facilitated in that the head segment is displaceably held on the groove. The term “displaceable” does not refer to the finished mullion-transom structure after end mounting since then the fastening means presses the pressing strip against the filling element and the components are rigidly fixed. Rather, the fastening means can be displaced along the groove during assembly with the head segment in order to position the at least one fastening means in the desired position the supporting profiled element. In the case of longer supporting profiled elements, a plurality of fastening means is used which need to be positioned at certain intervals so that the displaceability at the groove facilitates mounting.

In this case, the fastening means comprises a bolt, which is connected to the head segment. By means of the bolt, tensile forces can then be transmitted between the head segment and the pressing strip in order to pretension the latter towards the supporting profiled element. The bolt is fixed to the head segment, which is pivotably held in the pre-mounted position on the groove of the supporting profiled element. As a result, the bolt can be pivoted about an axis parallel to the longitudinal direction of the groove during assembly of the glass pane, which in the event of a contact between the bolt and the glass pane reliably prevents damage because the bolt can be moved compliantly to the side.

In a further embodiment of the invention, an elastic or resilient element is provided on the at least one fastening means in order to fix the at least one fastening means to the supporting profiled element. By means of such an elastic or resilient element, a pre-fixing of the fastening means is possible in such a way that it is displaced along the groove and then held at the desired position via the elastic or resilient element. It is thus also possible, in the case of obliquely or vertically arranged supporting profiled elements, to align the fastening means into the desired position and then to prefix it via the elastic or resilient element before the final fixing takes place after mounting of the filling elements and the pressing strip.

Preferably, the bolt is pretensioned to an upright position perpendicularly to the plane of the filling elements by the elastic or resilient element. When the bolt is pivoted, for example during mounting, the bolt can then be pivoted back into the upright position via the elastic or resilient element. Optionally, the bolt can be latched in a pivoted position in order to allow easier mounting of a filling element. After unlatching from the pivoted position, an alignment of the bolt to the upright position occurs then via the elastic or resilient element.

The head segment is preferably made of metal in order to enable the transmission of high forces. An elastic material, in particular a foam material or an elastomer, can be held on the head segment or a bolt of the fastening element. Alternatively or additionally, it is possible to provide an element pretensioned by a spring on the head segment, e.g. a holding element pretensioned against the groove.

For good guidance of the fastening means, the head segment can be designed essentially prismatically and preferably in the form of a cuboid, wherein the longitudinal extention of the parallelepiped preferably runs parallel to the longitudinal direction of the groove, so that jamming of the head segment can be reliably avoided.

Preferably, the elastic or resilient element is arranged on the side on the head segment facing away from the bolt and/or facing the bolt. In this case, by pressing the bolt against the groove, the fastening means can be displaced along the groove, which simplifies handling. The elastic element can be circumferentially arranged around the head segment like a sealing ring or a sealing band. Alternatively, the elastic element can be arranged in the form of a sealing cord or a foam strip in the longitudinal direction in the groove bottom of the groove.

Additionally or alternatively, an elastic or resilient element may be displaceably held on a bolt of the fastening means. The displaceable element can then be displaced along the bolt after the positioning of the fastening means in order to fix the fastening means in a clamping manner on the supporting profiled element.

In a further embodiment of the invention, a protruding rib which is preferably arranged centrally and runs parallel to the longitudinal direction is provided on the groove on a groove bottom. As a result, the fastening means can be held in the pre-fixed position on the groove and be pivoted about an axis extending parallel to the longitudinal direction of the groove. The rib thus forms a bearing in order to enable a pivoting movement in a certain region, which can be advantageous for the insertion of the filling elements.

Preferably, at least one recess is provided on the groove on the supporting profiled element, on which the head segment can be inserted into the groove. This is because the groove is formed in the form of an undercut and engages behind the head segment by means of webs. By forming one or more recesses, in which the inwardly directed webs of the groove are left open, the head segment can be easily mounted.

Furthermore, it is advantageous if the supporting profiled elements have a central groove for the fastening means and, in each case adjacent to the central groove, a groove for fixing sealing strips which can be arranged directly adjacent to the central groove, wherein the groove walls of the grooves essentially have the same height. As a result, the supporting profiled element can be formed in a particularly compact manner, and an intermediate space between the filling elements can be designed optimally for high thermal insulation by means of the insulating element. However, it is also possible to arrange the grooves offset in the supporting profiled element, e.g. a central groove for the fastening means can protrude over the two adjacent grooves for fixing sealing strips. Especially when different supporting profiled elements are used in a mullion-transom structure, different drainage planes can then be formed more easily.

Preferably, the head segment is connected to the bolt to pretension the pressing strip to the supporting profiled element. The bolt can then be fixed in a clamped or latched manner in an inclined position, which is not oriented perpendicularly to a plane of the filling elements. As a result, the bolt can respectively be aligned in an exactly inclined manner, e.g. in order to facilitate the mounting of a filling element.

According to a further aspect of a mullion-transom structure according to the invention, a threaded section of a fastening means is passed through an opening in a pressing strip, wherein the pressing strip is fixed in a clamping manner via a nut for fixing at least one filling element. As a result, the fastening means can be fixed in the outer region by the nut being unscrewed, while on the opposite side only a head segment is inserted into the groove on the supporting profiled element, so that the head segment must only be secured against being pulled out of the groove, which is enabled by providing an undercut formation of the groove in which webs which project inwards are provided on the groove walls. As a result, the supporting profiled element can be designed in a particularly compact manner on the outer side, which can also improve the thermal insulation.

Preferably, the pressing strip extends substantially over the entire length of the supporting profiled element. Then the pressing strip can be fixed via several fastening means to the supporting profiled element. The openings on the pressing strip are at least partially designed as elongated holes, which form a longitudinal extension parallel to the longitudinal direction of the groove of the supporting strip. As a result, better threading can be carried out when the pressing strip is fitted onto the threaded sections in order to then fix the pressing strip via the nut.

Furthermore, at least one recess for inserting a head segment of a fastening means is preferably provided on the supporting profiled element on the groove. As a result, the threading of the fastening means on the supporting profiled element can be simplified.

In the method according to the invention, a supporting profiled element is first mounted on a mullion-transom structure, and then a head segment of a fastening means is inserted into a groove on the supporting profiled element and positioned along the groove of the supporting profiled element. In this case, a plurality of fastening means can also be mounted along the groove of the supporting profiled is element, which fastening means are respectively held on the groove with a head segment. Then, at least one filling element is attached to the supporting profiled element, which is fixed on the edge side. For this purpose, a pressing strip with a plurality of openings for the passage of a respective threaded section of a fastening means is mounted, wherein the pressing strip is fixed by a respective nut to the threaded section so that the fastening means pretension the pressing strip to the filling element, thus fixing it in a clamped manner, especially between two sealing strips. By inserting a head segment into the groove, the groove can be formed in a comparatively short way since the head segment is simply inserted into the groove and engages behind it, so that the head segment is secured against being pulled out. The screw connection is made on the outer side by means of a nut, which is screwed onto a threaded section. As a result, the supporting profiled element can be designed in a particularly narrow and flat way, and, in addition, the mounting can be flexible since the fastening means can be positioned freely along the groove.

According to the method in accordance with the invention, the fastening means are pivoted before the mounting of a filling element and are aligned substantially perpendicularly to the plane of the filling element after mounting. As a result of the pivotable design of the filling elements, it is possible for the fastening means, which are usually made of metal, to be removed or further spaced from the region of the filling elements so that damage to the filling elements, which are at least partially made of glass, is avoided. Only after the positioning of the filling element can the fastening means be aligned adjacent to an end face of the filling elements.

In a preferred embodiment, before the insertion of a head segment of a fastening means, a recess is produced on the groove of the supporting profiled element for inserting the head segment. Since the groove is formed in the manner of an undercut, the insertion of a head segment at one or more points of the supporting profiled element can be facilitated by the manufacture of a recess in which at least the inwardly projecting webs are shortened or cut off at the groove.

Furthermore, markings for the alignment of the fastening means can be applied to the supporting profiled element. For a particularly good fastening of the filling elements, a uniform pressure is to be applied so that the fastening means are preferably positioned and fixed at regular intervals. To facilitate mounting, appropriate markings can already be applied to the supporting profiled element.

The invention is explained in closer detail below by reference to several exemplary embodiments shown in the enclosed drawings, wherein:

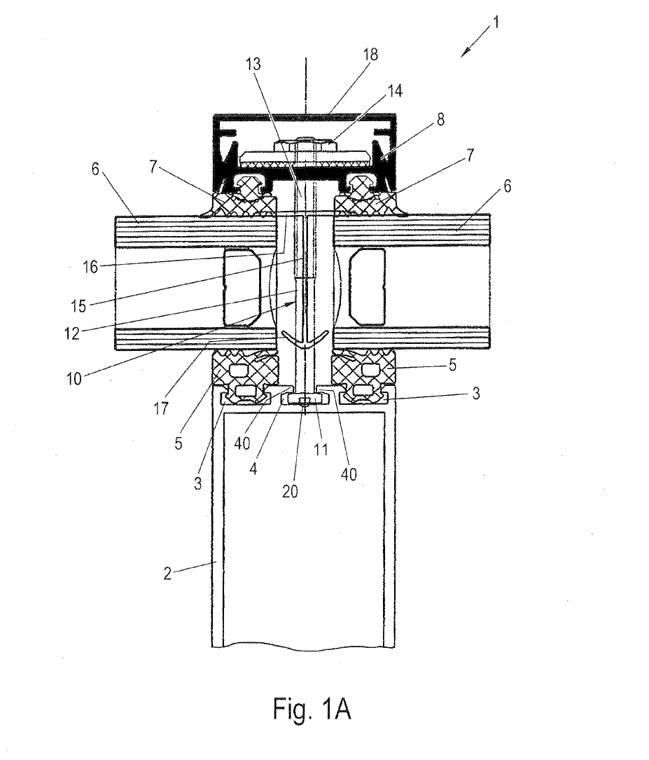

FIG. 1A shows a cross-sectional view through a mullion-transom structure according to the invention;

FIG. 1B shows a perspective view through the mullion-transom structure of FIG. 1A during mounting;

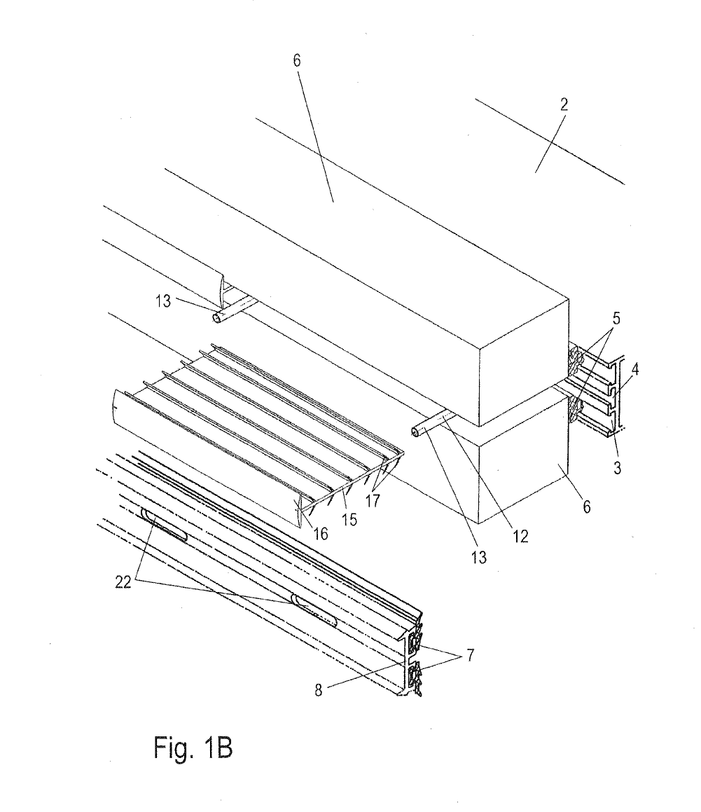

FIGS. 2A to 2C show two views through a modified mullion-transom structure;

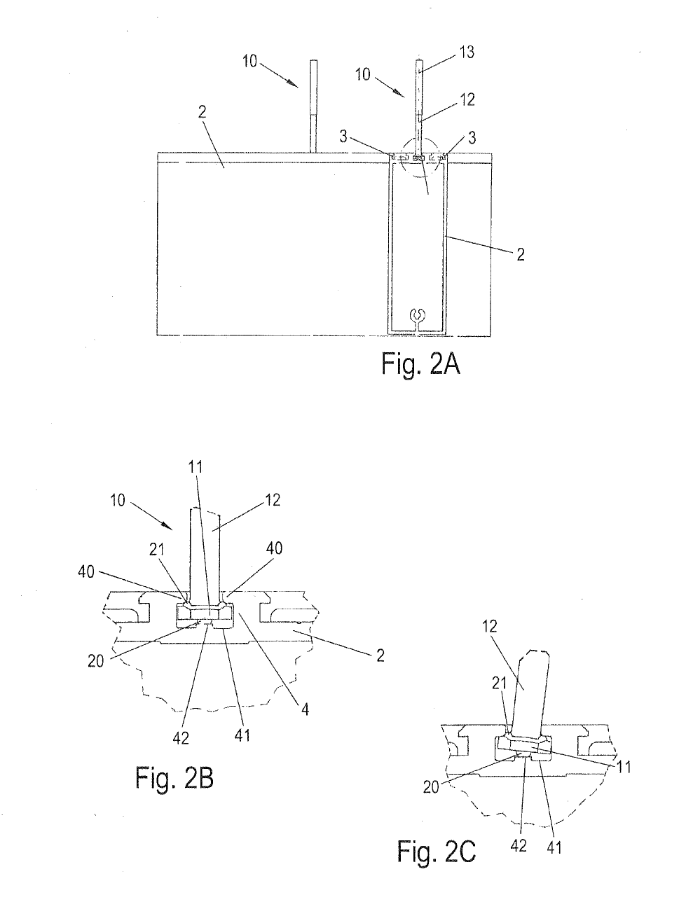

FIG. 3 shows a perspective view through a modified mullion-transom structure;

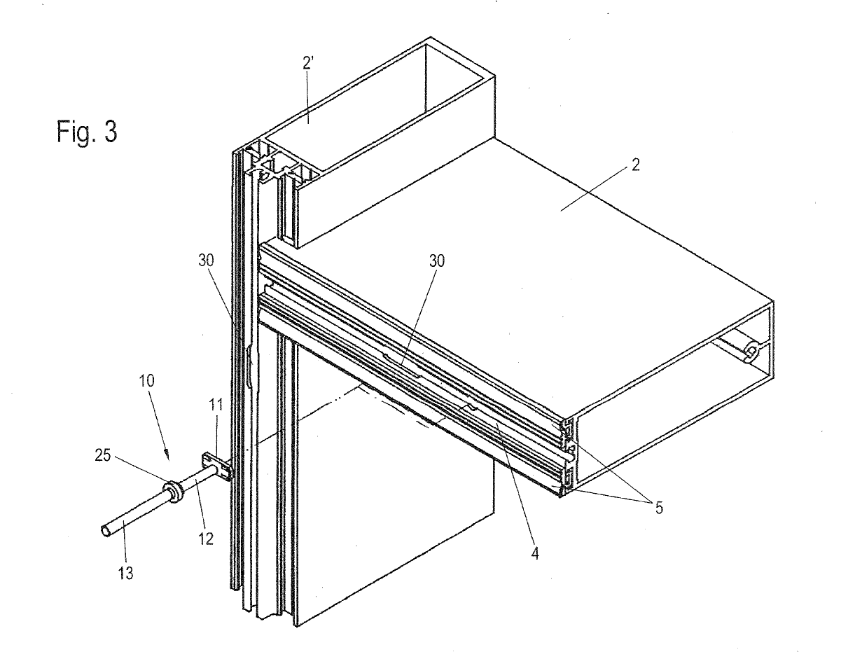

FIGS. 4A to 4C show several views of a further modified mullion-transom structure;

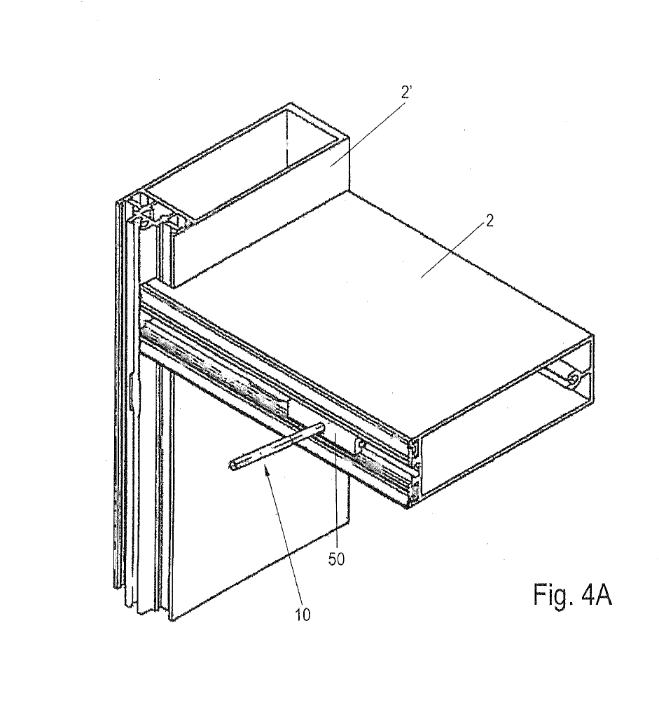

FIGS. 5A and 5B show two views of modified fastening means for a mullion-transom structure;

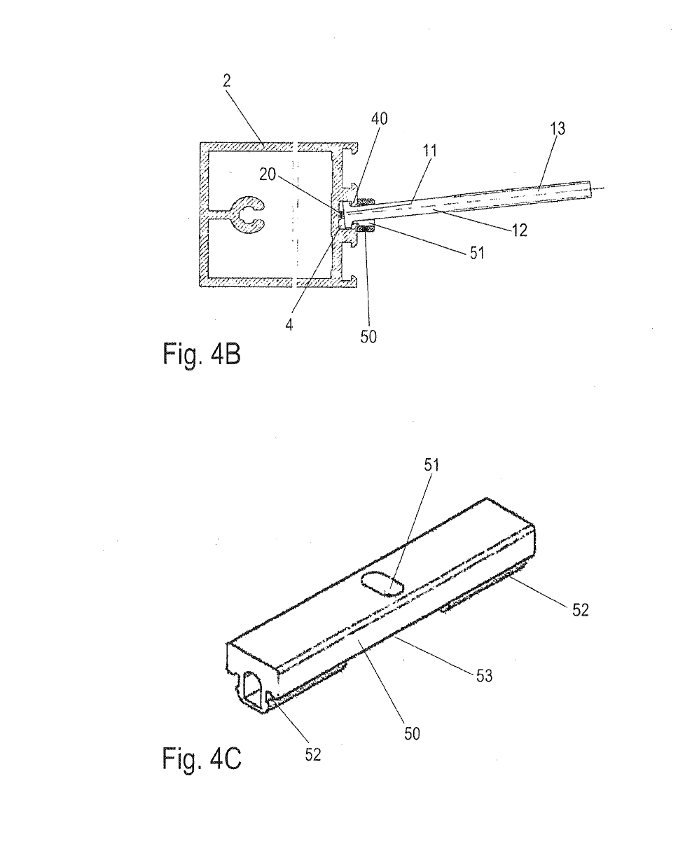

FIGS. 6A to 6D show several views of a further embodiment of a fastening means;

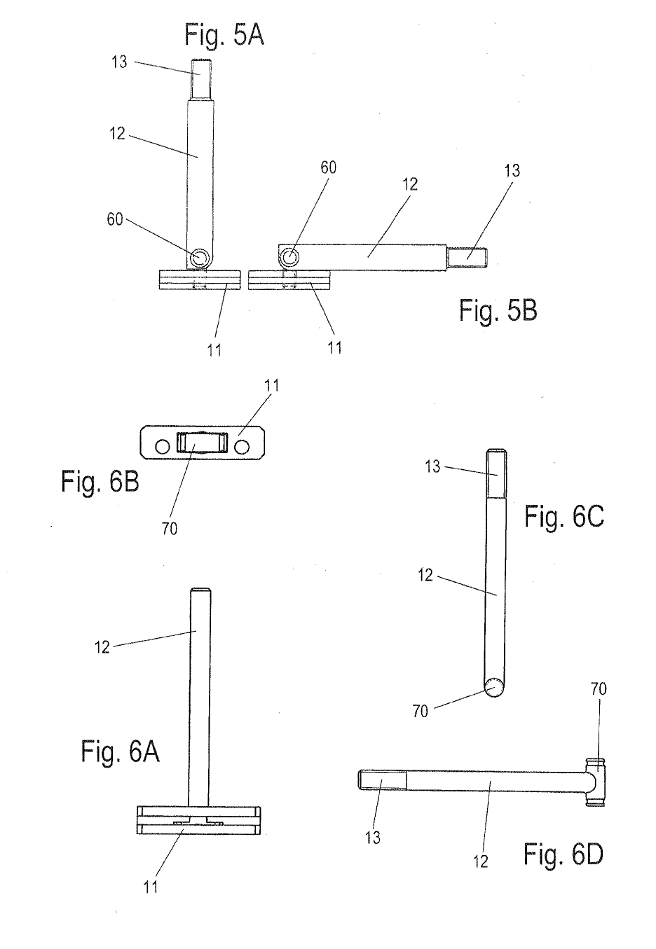

FIG. 7A and &B show two views of a modified fastening means;

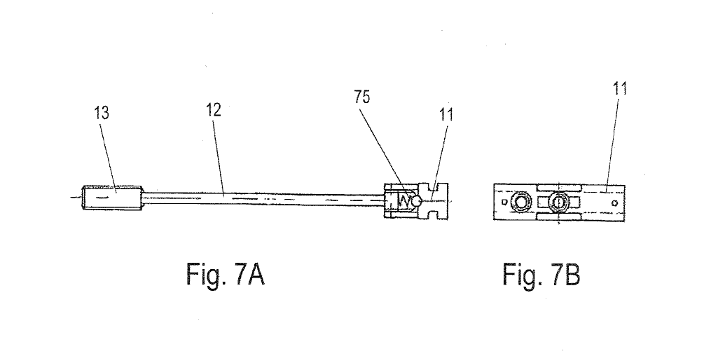

FIGS. 8A and 8B are views of a mullion-transom structure during mounting of the fastening means;

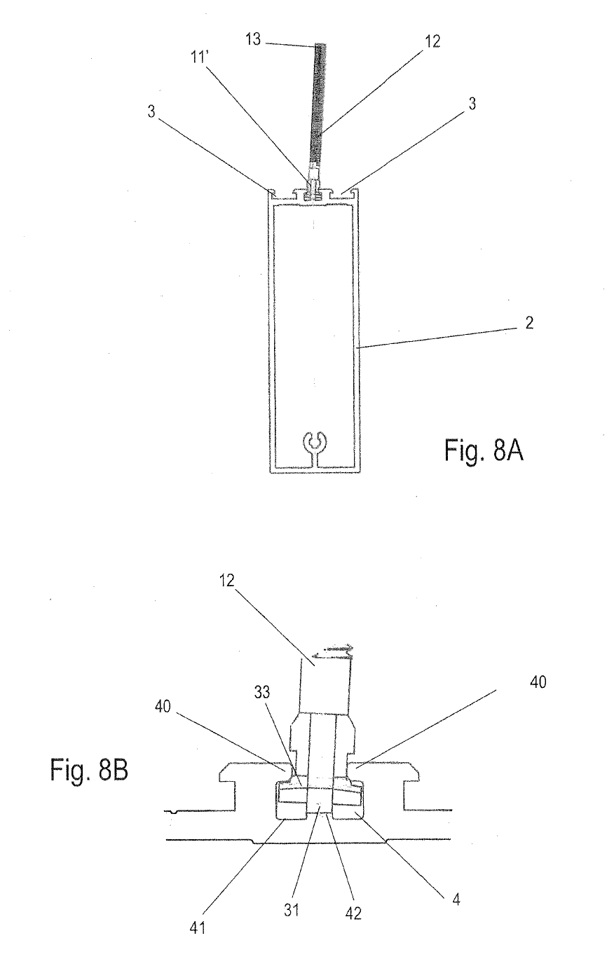

FIG. 9 shows a perspective view of the fastening means of FIG. 8;

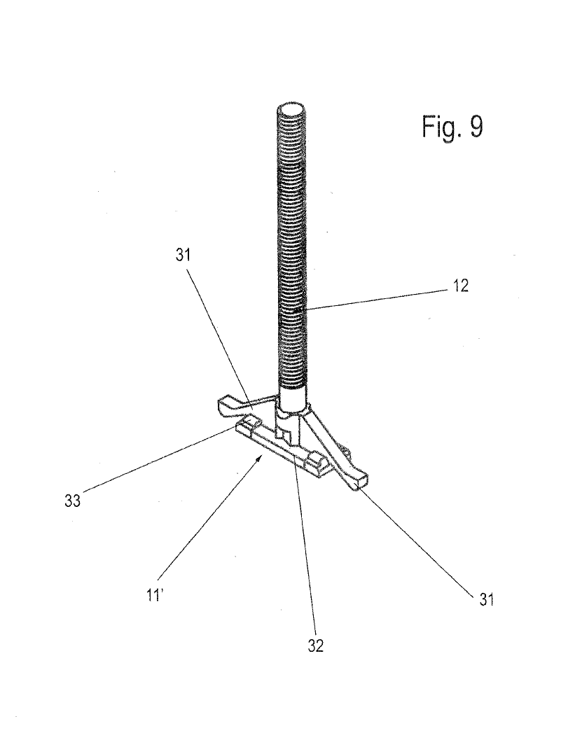

FIGS. 10A to 10C show several views of the head segment of the fastening means of FIG. 9;

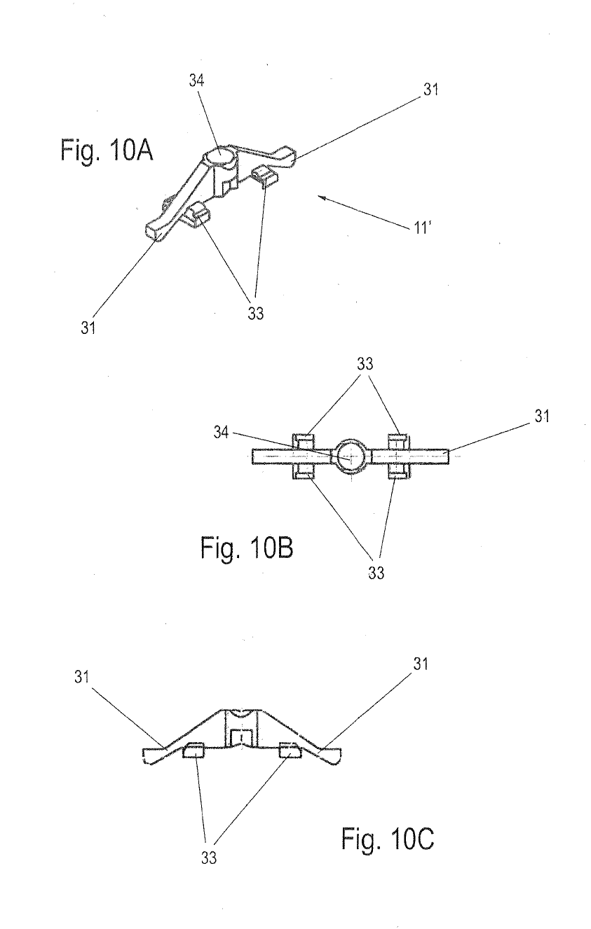

FIG. 11 shows a schematic view of a supporting profiled element prior to threading of the fastening means;

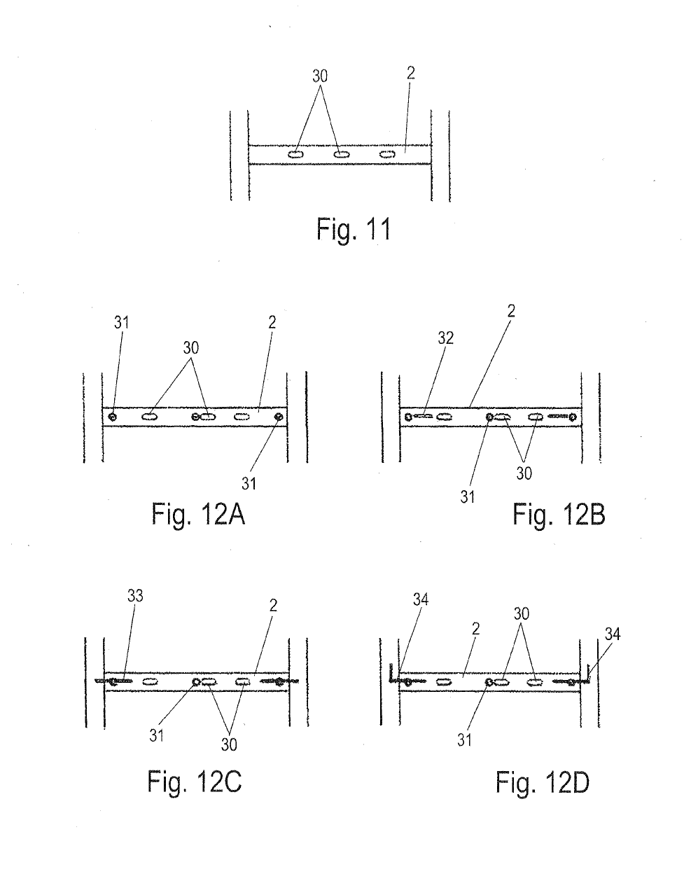

FIGS. 12A to 12D show several views of the supporting profiled element of FIG. 11 after mounting of the fastening means;

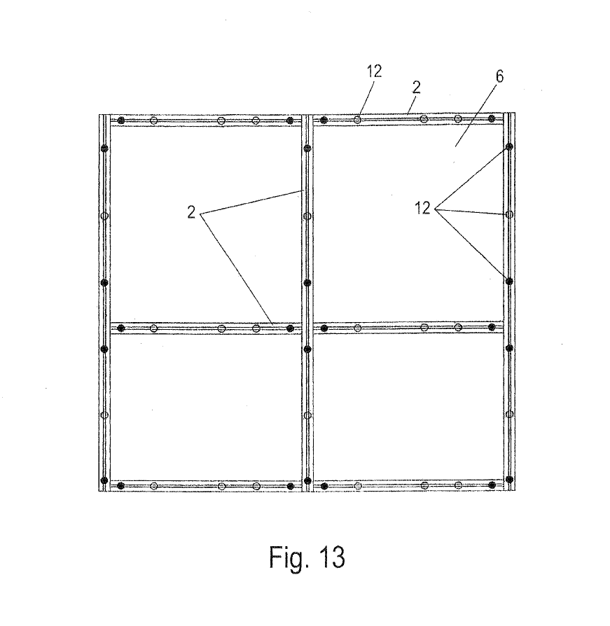

FIG. 13 shows a schematic view of a mullion-transom structure with fastening means, and

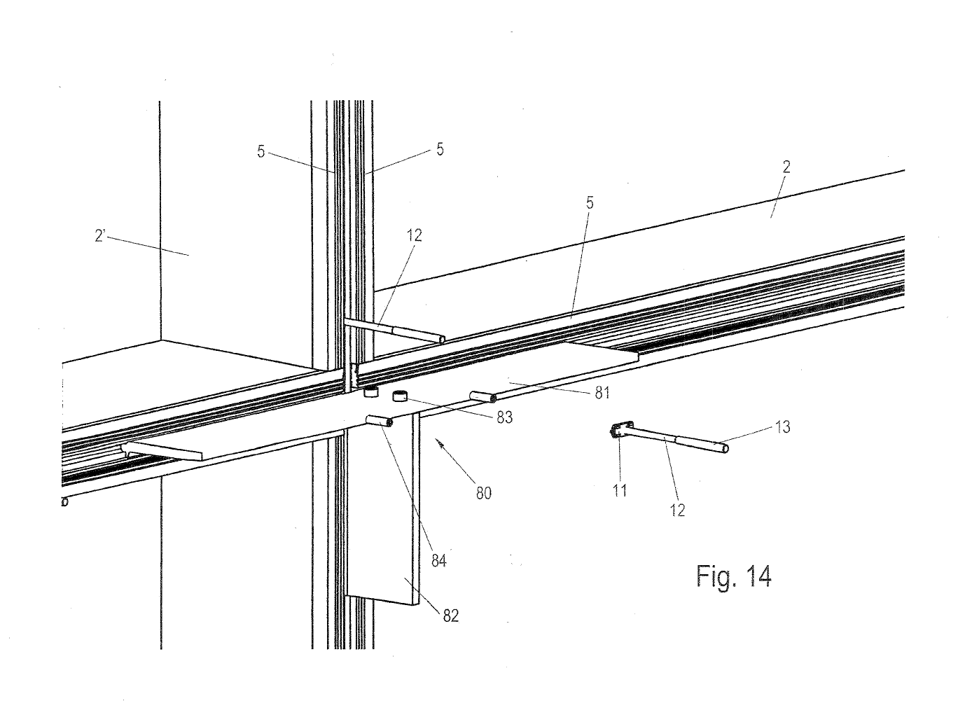

FIGS. 14 to 16 show several views of a mullion-transom structure during mounting.

A mullion-transom structure 1 comprises a supporting profiled element 2, which can be designed as a mullion or transom and is mounted, for example, on a façade, a glazed roof or a pitched roof. The supporting profiled element 2 has two parallel grooves 3 on an outer side, which surround a central groove 4. A sealing strip 5 is held on each groove 3 in order to support an edge of a filling element 6 in the form of an insulating glass pane. The filling element 6 is fixed to an outer side by outer sealing strips 7, which are held by means of a pressing strip 8. The pressing strip 8 is fixed to the supporting profiled element 2 by means of one or more fastening means 10, and the filling elements 6 are thereby clamped firmly between the sealing strips 5 and 7.

A fastening means 10, which is fixed to the supporting profiled element 2, comprises a head segment 11, which is accommodated and displaceably held in the groove 4. The groove 4 is formed in the form of an undercut and comprises webs 40 which project inwards on the groove walls and which engage behind the head segments 11 so that the latter cannot be pulled out of the groves 4. In this case, the head segment 11 is designed essentially prismatically [parallelepipedal] and can be displaced along the groove 4 until the fastening means 10 is arranged in the desired position. Then the further mounting can take place. It is also possible to form the head segment 11 so that it protrudes partially from the groove 4 and is not completely accommodated within the groove 4.

A bolt 12, which is firmly connected to the head segment 11, is provided on the fastening means 10, said bolt 12 being formed with a threaded section 13 in the region of the pressing strip 8. The bolt 12 may be fixed to the head segment 11 by threading, gluing, welding or other fastening techniques. A nut 14 is fixed to the threaded section 13 in order to pretension the pressing strip 8 in a clamping manner to the supporting profiled element 2. A cover profile 18 is further latched onto the outer side of the pressing strip 8.

Distributed over the length of the supporting profiled element 2, a plurality of fastening means 10 can be provided, which are positioned, for example, at distances between 20 cm-50 cm. In order to improve thermal insulation, a strip-shaped insulating element 15 can be provided in the intermediate space between adjacent end edges of the filling elements 6. The insulating element 15 has two protruding arms 16 which extend essentially parallel to the plane of the filling elements 6 and are clamped with an end section between the sealing strip 7 and an outer side of the filling elements 6. Furthermore, a web extends toward the supporting profiled element 2 at a right angle from the arm 16, on the end side of which projections 17 are formed, which can also be elastic for tolerance compensation with respect to the width of the gap between the filling elements 6. The intermediate space between the filling elements 6 can thus be thermally insulated, wherein the insulating element 15 can assume various forms.

In order to pre-fix the fastening means 10 along the supporting profiled element 2 during mounting, an elastic element 20 is provided on the head segment 11 on the side facing away from the pressing strip 8, e.g. a strip of foamed material, an elastomer, plastic or other materials, which strip is attached by gluing or pushed into a contour (not shown). The head segment 11 can be clamped in the groove 4 via the elastic element 20, so that, after the fastening means 10 has been displaced in the desired position, the fastening means 12 is held in a pre-fixed manner by the clamping forces, even if the supporting profiled element 2 is oriented obliquely or vertically. It is also possible to dispense with the elastic element 20 on the head segment 11 or to provide other means for fixing the head segment 11 of the fastening means 10 in a clamping manner, e.g. an element pretensioned by a spring.

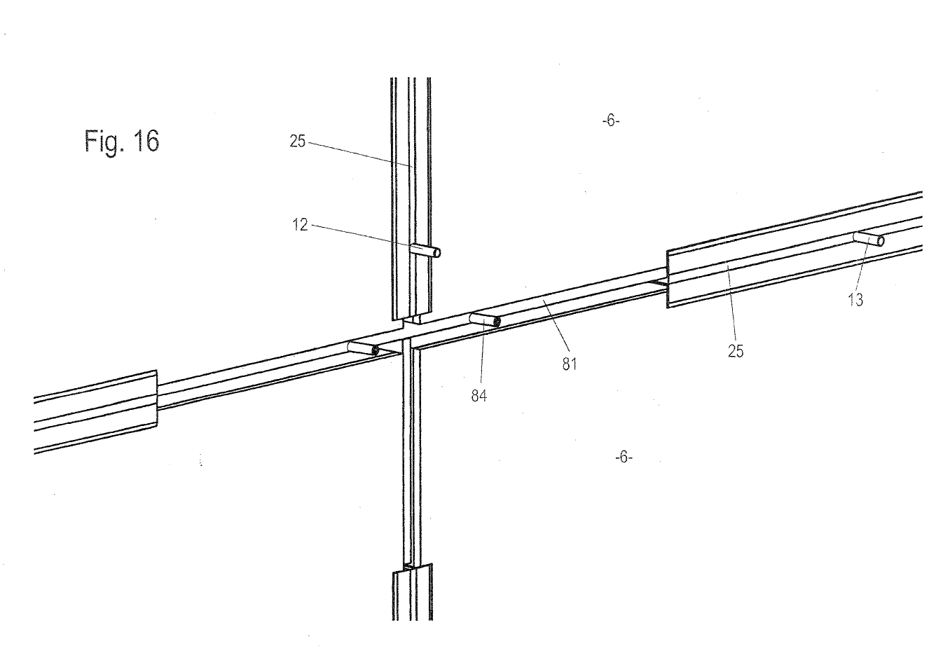

In FIG. 16, the mullion-transom structure 1 is shown during mounting. Filling elements 6, which rest against the sealing strips 5 on the edge, are already attached to the supporting profiled element 2. Between opposite end edges of the filling elements 6, bolts 12 of the fastening means 10 protrude, wherein a threaded section 13 is formed on the protruding section of the bolts 12. In FIG. 2, the insulating elements 15 are mounted, which are formed in the manner of strips and are selectively mounted on the bolts 12 or mounted in individual sections between the bolts 12. A plurality of strip-shaped projections 17 are formed on the web between the filling elements 6 instead of only one projection 17 in FIG. 1A, so that the intermediate space between the filling elements 6 is divided into a plurality of chambers, which improves heat insulation.

After the insulating elements 15 have been mounted, the pressing strip 8 is mounted on which sealing strips 7 have already been provided. The pressing strip 8 has openings 22 in the form of elongated holes at a distance x, which essentially corresponds to the distance x between two fastening means 10. In this case, the pressing strip 8 can have a plurality of openings 22, through which the threaded sections 13 are passed, over the entire length, for example with a length between 0.5 m and 5 m. As a result of the formation as an elongated hole, it is easier to compensate for tolerances with respect to the positioning of the fastening means 10. After the pressing strip 8 has been positioned, the nuts 14 can in each case be twisted onto the threaded sections 13 in order to fix the pressing strip 8.

In the following exemplary embodiments, the mullion-transom structure 1 is only explained in closer detail with regard to the supporting profiled element 2 and the fastening means 10, wherein the remaining components with respect to the filling elements 6, sealing strips 5 and 7 as well as the pressing strip 8 can be designed identically as in FIG. 1.

FIGS. 2A and 2B show a supporting profiled element 2 in which a head segment 11 of a fastening means 10 is fixed to the central groove 4. The head segment 11 is connected to a bolt 12, wherein an elastic element 21 is provided at the transition between the head segment 11 and the bolt 12, said resilient element 21 being partially in contact with the internally directed webs 40 of the groove walls. The elastic element 21 can also provide clamping forces for prefixing the fastening means 10 to the groove 4.

FIG. 2B shows that a further elastic element 20 is provided on the side facing away from the bolt 12, which rests on a rib 42 on a groove bottom 41. It is possible according to FIG. 2C by providing two elastic elements 20 and 21 on opposite sides of the head segment 11 that the bolt 12 is pivotably held on the groove 4 in a certain angular range, in particular about a pivot axis parallel to the longitudinal direction of the groove, which can simplify mounting, especially when the filling elements 6 are inserted. It is obviously sufficient to provide only the elastic element 20 or only the elastic element 21 for prefixing the fastening means 10 in a clamping manner. As a result of the arrangement of two elastic elements 20 and 21, however, the holding forces can still be increased during the prefixing.

FIG. 3 shows a further exemplary embodiment of a mullion-transom structure according to the invention, wherein a vertical supporting profiled element 2′ and a horizontal supporting profiled element 2 are provided. A fastening means 10, which has a substantially prismatic or square-shaped head segment 11 and a bolt 12 fastened thereto, is fixed to the supporting profiled element 2. An elastic element 25 is displaceably held on the bolt 12.

For the mounting of the fastening means 10, first the head segment 11 is inserted into a recess 30 of the groove 4 and then displaced along the groove 4. The recess 30 is formed in such a way that at least the inwardly projecting webs 40 have been removed to such an extent that the head segment 11 can be inserted into the groove 4 in order to be then displaced along the groove 4, so that the inwardly projecting webs 40 engage behind the head segment 11. As soon as the fastening means 10 is aligned in the desired position, the annular elastic element 25 can now be displaced along the bolt 12 until it rests on the webs 40 of the groove 4. As a result, the fastening means 10 can be fixed in a clamping manner via the elastic element 25, so that the further assembly can then take place.

Alternatively, the element 25 can also be a dimensionally stable and non-resilient structural part. For example, the bolt 12 can be provided with a thread on which the element 25 is screwed with an internal thread.

Furthermore, the element 25 can also be designed as a conical, wedge-shaped component of a clamping mechanism instead of as a ring in order to prefix the fastening means on the groove 4.

FIGS. 4A-4C show a further exemplary embodiment of a mullion-transom structure, in which a fastening means 10 is held on a supporting profiled element 2. An elastic element 20 is provided on the head segment 11 of the fastening means 10 on the side remote from the bolt 12, which elastic element may optionally be omitted. Furthermore, a profile section 50 is provided as an elastic element on the bolt 12, on which an opening 51 is formed, through which the bolt 12 is passed.

The profile section 50 can be made of an elastic material, in particular a plastic, an EPDM or a foamed material. The profile section 50 has, on opposite sides of the opening 51, foot elements 52, which are elastic and can be inserted into the undercut groove 4, so that they are fixed there in a clamping manner. The two foot elements 52 are separated from one another by a recess 53, on which the head segment 11 of the fastening means 10 can be accommodated. The opening 51 in the profile section 50 is not circular but rather formed as an oblong hole, wherein the longitudinal direction of the oblong hole extends perpendicularly to the direction of the groove 4, so that the bolt 12 can be pivoted in a certain angular range on the groove 4. It is, of course, also possible to form the opening 51 in a circular shape in order to dispense with such pivoting.

After positioning the fastening means 10 on the supporting profiled element 2, the profile section 50 can be inserted into the groove 4 on the foot elements 52 so that the bolt 12 is held securely and then the filling elements 6 and the pressing strip 8 can be mounted.

In order to introduce the head segment 11 of the fastening means 10 into the groove 4, it is possible to insert the fastening means 10 laterally into the groove 4 before mounting the supporting profiled element 2. Instead, the groove 4 can be opened with a recess in the region of the inwardly projecting webs 40 to such an extent that the head segment 11 of the fastening means 10 can subsequently be introduced into the groove 4 and displaced via this recess.

In the illustrated exemplary embodiment, different elastic elements 20, 21, 25 and 50 are shown in order to fix a fastening means 10 along a groove 4.The individual elastic elements 20, 21, 25 and 50 can be combined with one another as desired, wherein one or more such elastic elements 20, 21, 25 and 50 are preferably provided on each fastening means 10.

Furthermore, the displaceable head segment 11 can also be fixed at the desired position via the bolt 12 on the groove 4. Then the bolt 12 can be screwed into a threaded hole on the head segment 11 and is screwed for fixing into the head segment to the extent that the bolt 12 comes to lie against a bottom of the groove 4 and is fixed there in a clamping manner.

In FIGS. 5A and 5B, the modified fastening means is shown, in which a joint 60 is fixed to the head segment 11, on which the bolt 12 is pivotably held. The shape of the bolt 12 can optionally be chosen to be flat, round or with any other geometry.

FIGS. 6A to 6D show a further exemplary embodiment of a modified fastening means in which a bolt 12 is pivotably mounted on a substantially prismatic [parallelepipedic] head segment 11. For this purpose, the bolt is provided on its end with a cylindrical bearing pin 70, which is inserted into a receptacle within the head segment 11. The head segment 11 is provided with an oblong hole on the side facing the bolt 12, so that the bolt 12 is designed to be pivotable in a predetermined angular range, e.g. between 10° and 40°. As a result, during mounting of the filling element 6, the bolt 12 can be pivoted on one side to the opposite side. The bolt can thereby be clamped or locked in the inclined position in order to prevent a pivoting movement of the bolt 12 during mounting.

FIGS. 7A and 7B show a further fastening means, in which a bolt 12 is connected to a head segment 11 and has a threaded section on the opposite side. Between the bolt 12 and the head segment 11, there is an articulated mechanism with a spring 75, which ensures that the bolt 12 can be pivoted when the bolt 12 is pushed into the head segment 11. By pushing and pivoting the pin 12, the latter can be pivoted out of the mounting area of the filling elements 6. After the pre-mounting of the filling elements 6, the bolt 12 can then be pivoted back into the position perpendicular to the plane of the filling elements.

Other mechanisms for pivoting the bolt 12 can also be used to facilitate the mounting of the filling elements 6.

In a further embodiment, a connection between adjacent fastening means 10 and/or the head segments 11 is possible, so that they are arranged in a row next to one another, as in the case of a pearl cord. The connection between the fastening means 10 and/or the head segments 11 can alternatively be fixed firmly via bars or flexibly, e.g. via a cable, especially a wire rope. It can be ensured that the same distance between the fastening means 10 or the head segments 11 is always present via the connection.

In FIGS. 8A and 8B, a bolt 12 with a head segment 11′ is mounted on the supporting profiled element 2. As shown in FIG. 8B, the bolt 12 is pivotable about an axis parallel to the longitudinal direction of the groove in this pre-mounted position, in which no filling elements 6 have yet been mounted. For this purpose, the groove 4 has a central rib 42 on the groove bottom parallel to the longitudinal direction, on which arms 31 of the head segment 11′ are supported. Furthermore, support elements 33 are provided on the inwardly directed webs 40 of the groove 4.

The bolt 12 with the head segment 11′ is shown in detail in FIG. 9. The head segment 11′ has two arms 31 extending outwardly from the bolt 12 on opposite sides and have a bearing surface on their underside, which rests on the upper side of the rib 42. A plate 32, on which the support elements 33 are designed in the form of four projections which rest on the underside of the webs 40, is provided at a distance from the arms 31.

The head segment 11′ is shown in detail in FIGS. 10A to 10C. The head segment 11′ preferably consists of an elastic material, especially plastic. After the insertion of the head segment 11′ into the groove 4, the arms 31 can be supported on the rib 42 with a certain pretension so that the bolt 12 is moved to an upright position in which it protrudes essentially perpendicularly from the plane of the filling elements. The bolt 12 can thus be pivoted according to FIG. 8B by a few degrees, e.g. by up to 5° or up to 10°, in order to reliably prevent damage in the case of a contact of the bolt 12 with an edge of a glass pane of a filling element 6. When the glass pane is removed again from the bolt 12, the glass pane is automatically pivoted back to the upright position by the pretensioning of the head segment 11′.

The bolt 12′ preferably consists of a metal pin with an external thread. It is also possible to cover the bolt 12 in the region of the filling elements 6 with a sheath, e.g. a sleeve of plastic or an elastic material, so that there is further security against damage to the edge of a glass pane. Only the outermost portion of the bolt 12 has a threaded section 13 for the mounting of the nut 14 and will therefore not be provided with a sheath or at least with a detachable sheath which is removed after the pre-mounting of the filling elements 6.

For mounting the mullion-transom structure, the supporting profiled element 2, which may be designed as a mullion or transom, is first mounted, wherein in FIG. 11 the supporting profiled element 3 is mounted as a horizontal transom. One or more recesses 30 are provided on the supporting profiled element 2, on which the inwardly projecting webs 40 of the groove 4 are cutoff. As a result, a head segment 11 of a fastening means 10 can in each case be inserted into the recess 30 and then displaced along the groove 4.

Before or afterwards, markings 31 which fix the distance x between two fastening means 10 are attached to the supporting profiled element 2. For this purpose, the markings can be provided on the groove walls or in other positions on the supporting profiled element 2, so that, after the threading of the fastening means 10, these can be positioned correspondingly.

In FIG. 12A, a glass support is provided on the supporting profiled element 2 adjacent to the mullion, from which a bolt 31 for a nut protrudes. The glass support serves to position the pressing strip 8.

In FIG. 12B, a glass support 32 is mounted on the supporting profiled element 2 on opposite sides, which is fixedly connected to the supporting profiled element 2 and at least partially receives the weight loads of a filling element 6.

FIG. 12C schematically shows a glass support 33, which is fixed not only to the supporting profiled element 2, but additionally to the adjacent supporting profiled element in the form of the mullion.

FIG. 12D shows a modified glass support 34 which is L-shaped or cross-shaped and is fixed both to the mullion as well as to the supporting profiled element 2 designed as a transom. The mounting of the filling elements can therefore be carried out independently of a design of a glass support 32, 33 or 34.

FIG. 13 once again schematically shows a mullion-transom structure in which vertical and horizontal supporting profiled elements 2 are provided in which respective fastening means with a bolt 12 are attached to a central groove, which bolt can be attached to a fastening means 10 or to a glass support. The alignment of the bolts 12 can occur in accordance with the preceding method steps.

In the exemplary embodiment shown, the bolts 12 are rigidly held on the head segment 11. It is also possible to provide the bolts 12 with a pivotable configuration, so that they can be pivoted before the mounting of the filling elements 6, e.g. parallel to the groove 4 or away from the filling element 6, in order to avoid damage to the glass panes of the filling element 6.

In the exemplary embodiments shown, the head segment 11 is completely accommodated in the groove 4. It is also possible to provide a head segment which protrudes partially from the groove 4, which can improve the guidance of the fastening means 10 along the groove 4.

FIG. 14 shows a mounting position of the mullion-transom structure, in which a vertical supporting profiled element 2′ is connected to a horizontal further supporting profiled element 2 at a crossing region. Fastening means 10 are fixed to both supporting profiled elements 2 and 2′, which comprise a bolt 12 with a threaded section 13 arranged at the end side. The fastening means 10 also comprise a substantially parallelepipedal or strip-shaped head segment 11, which is inserted into the central groove 4 of the supporting profiled elements 2 or 2′, wherein corresponding recesses can be provided for this purpose on the central groove 4, on which the inwardly protruding webs 40 are cut off.

A glass support 80, which has a horizontal support part 81 and a vertical suspension part 82, is provided in the intersection region of the supporting profiled elements 2 and 2′. The suspension part 82 and the support part 81 are fixed to one another by means of screws 83. Threaded sections 84 protrude from the support part 81, on which a nut 14 can be secured for the purpose of fixing a pressing strip 8, as has already been shown in FIG. 1.

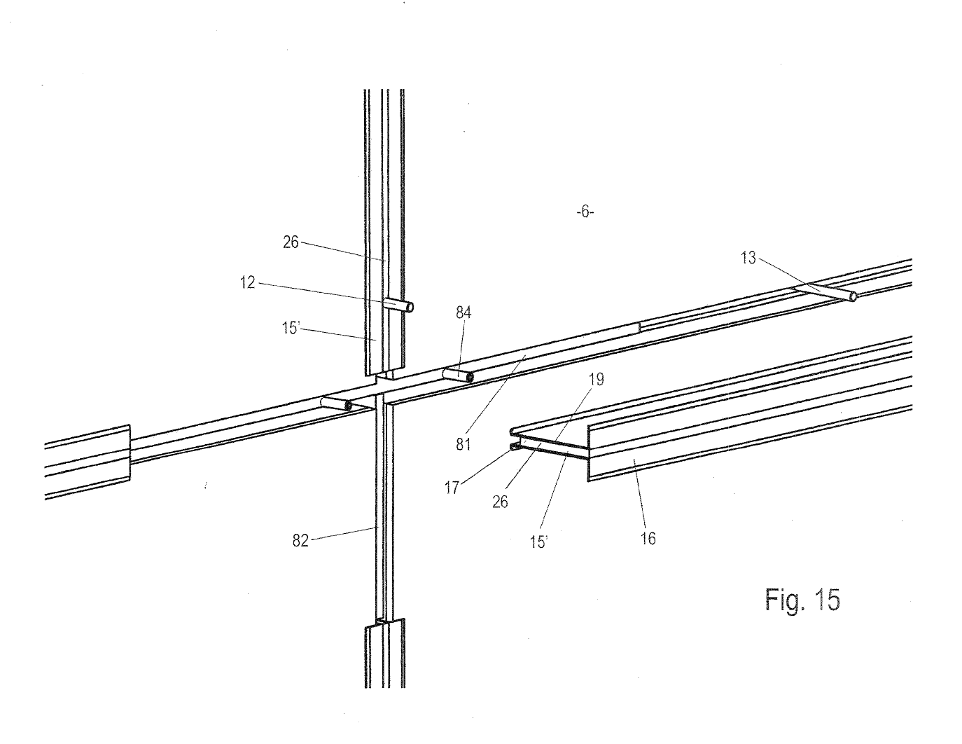

FIG. 15 shows that filling elements 6, in particular insulating glass panes, have already been applied to the sealing strips 5. In addition, insulating elements 15′ are respectively arranged between two adjacent filling elements 6, which are inserted onto the bolts 12. The insulating elements 15′ are formed in a modified manner in comparison with FIG. 1. The insulating elements 15′ have two webs 19 between which a filling material 26, in particular a material which is well heat-insulating, for example a foam, is provided. The bolts 12 are passed through the soft filling material 26 and thereby guided through the webs 19 of a harder material, for example a plastic, so that a threaded section 13 of the fastening means 10 protrudes outwards. The upper filling elements 6 can thereby be supported directly or indirectly on the support part 81 of the glass support 80 in some sections. In the region of the glass supports 80, a threaded section 84 also protrudes from the plane of the filling elements 6.

In FIG. 16, the insulating element 15′ has also been pushed onto the fastening means 10, wherein the bolts 12 of the fastening means 10 pass through the filling material 92. The bolt 12 of the fastening means 10 can be sheathed with an elastic insulating material to prevent the glass-metal contact.

For the mounting of the pressing strip 8, the openings for the threaded sections 84 are first inserted onto the glass supports 80, wherein the threaded sections 84 preferably protrude farther than the bolts 12 of the fastening means 10. The threaded sections 84 are not displaceable or pivotable in their position. The openings on the pressing strip 8 for mounting on the threaded sections 84 can be designed as oblong holes, the longitudinal extension of which is aligned perpendicularly to the longitudinal direction of the groove 4 in order to facilitate the placing of the pressing strip 8. The pressing strip 8 is thus initially placed on threaded sections 84 at opposite ends. Only then are the movable middle fastening means 10 threaded at the openings 21, e.g. under a pivoting movement of the pressing strip 8. It is advantageous in this case if the fixed threaded sections 84 are somewhat longer than the loose fastening means 10 in order to prevent jamming of the fastening means 10. By mounting the nuts 14, a uniform pressure can then be applied to the pressing strip 8 by the fastening means 10 and the threaded sections 84.

Since the fastening means 10 are displaceable and pivotable during mounting, simple mounting can occur on the openings 21 which are designed as oblong holes. The possibility of pivoting fastening means 10 improves the “threading” of fastening means 10 through the pressing strip 8.

In an alternative mounting method, the fastening means 10 can also be threaded at the openings 21. In this case, it is advantageous if the loose fastening means 10 are slightly longer than the fixed fastening means in the form of the threaded sections 84, in order to additionally prevent constraints when the pressing strip 8 is inwardly pivoted and simultaneous threading on the fixed thread sections 84.

### LIST OF REFERENCE NUMERALS

1 Mullion-transom structure
2 Horizontal supporting profiled element
2′ Vertical supporting profiled element
3 Groove
4 Groove
5 Sealing strip
6 Filling element
7 Sealing strip
8 Pressing strip
10 Fastening means
11, 11′ Head segment
12 Bolt
13 Threaded section
14 Nut
15 Insulating element
16 Arm
17 Projection
18 Cover profile
19 Cover profile
20 Elastic element
21 Elastic element
22 Openings
25 Element
26 Filling material
30 Recess
31 Arm
32 Plate
33 Support element
40 Web
41 Groove bottom
42 Rib
50 Profile section
51 Opening
52 Foot element
53 Recess
60 Hinge
70 Bearing pin
75 Spring
80 Glass support
81 Support part
82 Suspension part
83 Screw
84 Threaded section
x Distance

1. A mullion-transom structure, comprising;
a supporting profiled element upon, on which at least one filling element is retained at an edge,
a pressing strip by which the at least one filling element is pressed toward the supporting profiled element,
at least one fastening means for retaining the pressing strip is on the supporting profiled element,
wherein the at least one fastening means engages in a central groove on the supporting profiled element,
wherein the groove is formed with an undercut and the at least one fastening means is displaceably retained with a head segment in the groove,
wherein the at least one fastening means comprises a bolt that is connected to the head segment, and
wherein the bolt is fixed to the head segment, and the head segment is pivotably held in a pre-mounted position on the groove of the supporting profiled element.

2. The mullion-transom structure according to claim 1, wherein an elastic or resilient element is provided on the at least one fastening means to fix the at least one fastening means to the supporting profiled element.

3. The mullion-transom structure according to claim 1, wherein the head segment is made of metal, and wherein an elastic element made of a foamed material or an elastomer is retained on the head segment or the bolt.

4. The mullion-transom structure according to claim 1, wherein the head segment includes an element pretensioned by a spring is-provided thereon.

5. The mullion-transom structure according to claim 1, wherein the head segment substantially prism-shaped or cuboid-shaped.

6. The mullion-transom structure according to claim 2, wherein the elastic or resilient element is arranged on a side of the at least one fastening means the side facing the bolt, facing away from the bolt, or arranged circumferentially on the head segment.

7. The mullion-transom structure according to claim 2, wherein the elastic or resilient element is displaceably held on the bolt of the at least one fastening means.

8. The mullion-transom structure according to claim 1, wherein the groove has at least one recess on the supporting profiled element, and wherein the head segment can be inserted into the central groove on the at least one recess.

9. The mullion-transom structure according to claim 2, wherein the elastic or resilient element pretensions the bolt to an upright position perpendicular to a plane of the filling elements and, wherein during pivoting, if of the bolt moves out of the upright position, the elastic or resilient element pivots the bolt back again to the upright position.

10. The mullion-transom structure according to claim 1, wherein in each case, adjacent to the central groove, is a groove for fixing a sealing strip, and wherein the groove for fixing and the central groove are formed with groove walls with wall heights that are the same.

11. The mullion-transom structure according to claim 1, wherein in an inclined position, the bolt is not oriented perpendicularly to a plane of the filling elements, whereby the the bolt can be fixed in a clamped or latched manner in the inclined position.

12. The mullion-transom structure according to claim 1, wherein a connection is provided between adjacent ones of the at least one fastening means, the head segments or both and wherein said connection defines a distance between the adjacent ones of the fastening means the head segments or both.

13. The mullion-transom structure according to claim 1, wherein the bolt is surrounded, at least in sections, by a sleeve made of a plastic or an elastic material.

14. A mullion-transom structure, comprising:
a supporting profiled element,
a first groove formed on the supporting profiled element,
several spaced fastening means, each with a head segment, are retained on the first groove, wherein each of the several fastening means has a threaded section,
a pressing strip with a guide opening,
wherein each threaded section is guided through an opening in the pressing strip,
wherein the pressing strip is fixed in a clamping manner via a nut for fixing at least one filling element, and
wherein the opening in the pressing strip is formed at least partly an oblong-shaped opening with a longitudinal extension that is substantially in parallel with a longitudinal direction of the first groove of the supporting strip.

15. The mullion-transom structure according to claim 14, wherein the pressing strip extends over an entire length of the supporting profiled element.

16. The mullion-transom structure according to claim 14, wherein the first groove on the supporting profiled element includes at least one recess for inserting a head segment of the several fastening means.

17. The mullion-transom structure according to claim 1, wherein the supporting profiled element includes a glass support at a crossing region and wherein at least one threaded section protrudes from the glass support for fixing the pressing strip.

18. The mullion-transom structure according to claim 17, wherein the at least one threaded section protrudes farther beyond a plane of the filling elements than bolts of the several fastening means protrude beyond said plane.

19. A method for mounting a mullion-transom structure, comprising the steps of:
mounting a supporting profiled element to a mullion-transom structure;
inserting a head segment of a fastening means into a groove on the supporting profiled element and positioning the fastening means along the groove of the supporting profiled element;
repeating the step of inserting until a desired number of fastening means is provided on the supporting profiled element;
placing at least one filling element on the supporting profiled element;
mounting a pressing strip with a plurality of openings for the passage of a respective threaded section of the fastening means,
fixing the pressing strip by a nut on the threaded section,
wherein the fastening means are pivoted before the mounting of a filling element and are oriented essentially perpendicular to the plane of the filling elements after mounting.

20. The method according to claim 19, wherein the first groove is formed on the supporting profiled element in an undercut manner and before the step of inserting, at least one recess is produced on the first groove of the supporting profiled element for inserting a head segment.

21. The method according to claim 19, further including applying markings for alignment of the fastening means, to the supporting profiled element.

22. The method according to claim 19, wherein the pressing strip is initially placed at opposite sides on a threaded section of a glass support, and thereafter the fastening means arranged between the glass supports are threaded into openings of the pressing strip.
